(19) United States
(12) Patent Application Publication
(10) Pub. No.: US 2024/0145663 A1
(43) Pub. Date: May 2, 2024

(54) COLD SPRAY OF SOLID-STATE BATTERIES

(71) Applicant: Lawrence Livermore National Security, LLC, Livermore, CA (US)

(72) Inventors: Jianchao Ye, Tracy, CA (US); Alexander A. Baker, Pleasanton, CA (US); Harry B. Radousky, San Leandro, CA (US)

(21) Appl. No.: 18/381,560

(22) Filed: Oct. 18, 2023

Related U.S. Application Data
(60) Provisional application No. 63/381,164, filed on Oct. 27, 2022.

(51) Int. Cl. H01M 4/04; H01M 4/131

(52) U.S. Cl. CPC H01M 4/0419; H01M 4/0407; H01M 4/131

(57) ABSTRACT

An active layer for a battery includes a cold-sprayed composite layer positioned above a substrate, where the composite layer comprises an active component, a conductive component, and a binder. The composite layer is formed from a solid-state material. A method of making a composite layer includes forming a composite layer on a substrate by cold spraying particles of a composite powder above the substrate. The composite powder includes an active component, a conductive component, and a binder.

### RELATED APPLICATIONS

This application claims priority to Provisional U.S. Appl. No. 63/381,164 filed on Oct. 27, 2022, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to solid-state batteries, and more particularly, this invention relates to a method of cold spray fabrication of solid-state batteries.

### BACKGROUND

Solid-state lithium batteries are promising to replace conventional Lithium (Li) ion batteries for much higher energy density and intrinsic safety. The critical challenges in the commercialization of solid-state batteries (SSBs) include the high manufacturing cost and poor cycling stability. State-of-the-art technologies are either expensive (e.g., vacuum deposition of solid-state electrolytes (SSEs), LiCoO₂, Cu layer, etc.), and/or have unrealistic shape factors (e.g., hydraulic press produces a battery that is too thick, too small, etc.). To reduce the cost of SSBs (e.g., <$100/kWh) and achieve>400 W·h/kg specific energy, or >1000 W·h/L volumetric energy density, anode-free SSBs are of particular interest.

A Li battery that does not include anode active materials such as graphite, silicon, or even metallic lithium may have energy density that can achieve 1500 W·h/L. However, an all solid-state lithium battery is difficult to manufacture in a practical way and it is difficult to achieve a high performance design. Moreover, manufacture of anode-free all-solid-state lithium batteries (ASSLB) has been challenging, and in particular challenging to achieve a high performance design. It is critical to overcome challenges such as tensile stress induced cracking, interfacial delamination, and insufficient solid-solid contact. These challenges lead to large internal resistance that deteriorate the battery performance. Moreover, the processing cost needs to be dramatically reduced by preferably reducing the number of procedures and the duration of time for processing. In addition, it is desirable to consider less environmental requirement for air-sensitive materials (e.g., metallic Li).

Solid-state batteries are less likely to be flammable and have a high conductivity, and thus, solid-state batteries have a capability of being fast charging without a risk of flammability. The current problems with fabricating a solid-state battery include efficient manufacture of dense solid-state electrolyte, dense anode components, dense cathode components, etc. and how to integrate the components together to have a beneficial interfacial properties. Some studies report sintering the material, but the sintering process requires a very high temperature that is not compatible with various materials of the solid-state battery. Moreover, it is important that the solid-state cathode and solid-state electrolyte layers have sufficient solid-solid contact at the interface of the layers.

There have been several efforts to make anode-free SSBs. One example includes thin film batteries based on lithium phosphorus oxynitride (LiPON) solid-state electrolyte (SSE). Using a physical vapor deposition of LiCoO₂/LiPON/Cu, the formed structures demonstrate>1000 cycles of fast charging/discharging capability. However, the film thicknesses of the structures are limited to being extremely thin (<10 μm for LiCoO₂), which leads to very low energy densities. In addition, the deposition rate for forming the thin films is slow, about 10 nanometers/minute (nm/min). Moreover, the high cost and limited scalability also restrict broad application of the formation process.

Other efforts focus on the development of thick composite cathodes (tens of micrometers) integrated with sulfide-, oxide-, and halide-based SSEs. The reported fabrication methods include hydraulic press and hot press and have limited scalability and integrability. Although sulfide- and halide-based SSEs can be densified at room temperature by cold pressing due to their low modulus, the integration with cathode and anode layers is complicated by the electrochemical stability issue. Oxide based SSEs such as garnet-type doped lithium lanthanum zirconium oxide (Li₇La₃Zr₂O₁₂, LLZO) electrolytes have very good electrochemical stabilities with both metallic lithium and cathode materials. However, the densification of the layers requires high sintering temperature, which leads to processing incompatibility with cathode and carbon materials. However, fabrication of solid-state batteries using external applied force results in layers having interfacial delamination during densification. Moreover, these processes limit the shape of the battery according to the limits of the hydraulic press, e.g., flat, and the layers for pressing need to be fairly thick in order to achieve a desirable energy density, and thus it is difficult to fabricate thin layers, such that the formed layers are prone to brittle cracking.

Supersonic spray coating that primarily uses an aerosol deposition approach has been reported to the manufacture of electrodes for lithium ion batteries. In these examples, a solvent such as dimethylformamide is used to disperse particles; and the suspension is injected into a hot carrier gas to impact the substrate with supersonic speed. This study has been limited to anode development. A solvent with the particles suction directing through a nozzle onto a substrate, but the deposition mechanism relies on the presence of solvent. The reliance on a solvent for deposition increases the processing cost and environmental impact.

Another study using supersonic spray coating to manufacture solid-state lithium ion batteries relies on a mixture of metal binder (e.g., ductile metal materials) with cathode or anode active materials that form essential particle agglomerations in a solvent for spraying onto a substrate. As reported, the metal additives function to bind the cathode or anode active materials since traditional cold spray approaches struggle to deposit non-ductile materials. However, the drawback of this process is the inclusion of metal powders in electrodes reduces the overall energy density by lowering the content of active materials. The presence of metal binders often degrades the functional performance of the deposited material by reducing its effective density and filling fraction. The metal binder powders may also block the Li+ transport within the electrodes as those metals are typically not Li+ conductive.

For optimal cold spray adhesion of powders, a balance of material hardness, density, and ductility, mixed with the powder size distribution provides a process window for a particular application of cold spray technology. Although cold spray technology has been generally understood to be limited to metals, studies of magnet and thermoelectric material have shown brittle functional materials can be used in cold spray technology. Materials of batteries, however, have more complexity, are difficult to work with, require special conditions, and thus, cold spray methodologies have not been demonstrated with materials the comprise a battery. Some materials are not amenable to adherence caused by the highly energetic process of the cold spray method. For example, an extremely hard material such as boron carbide has not been demonstrated to adhere to a substrate using cold spray technology.

Implementation of cold spray technology may solve these issues since temperatures used in cold spray technology avoids reactions of the materials. However, the materials of a solid-state battery may be challenging to adapt for cold spray methods. Thus, it remains elusive whether a solid-state battery may be formed exclusively from solid materials.

### SUMMARY

In one aspect, an active layer for a battery includes a cold-sprayed composite layer positioned above a substrate, where the composite layer comprises an active component, a conductive component, and a binder. The composite layer is formed from a solid-state material.

In another aspect, a method of making a composite layer includes forming a composite layer on a substrate by cold spraying particles of a composite powder above the substrate. The composite powder includes an active component, a conductive component, and a binder.

In yet another aspect, a method of forming a solid-state battery having a cylindrical cell configuration includes rotating a substrate about the longitudinal axis of the substrate while the following layers are formed thereabove by cold spraying each of the layers: a composite layer comprising particles of a composite powder including an active component, a conductive component, and a binder, an insulator layer comprising particles of an insulator material powder, the insulator layer formed above a first portion of the composite layer, an electrolyte layer comprising particles of an electrolyte powder, the electrolyte layer formed above a second portion of the composite layer, wherein the first portion of the composite layer is different than the second portion of the composite layer, and a current collector layer comprising particles of a current collector material powder, the current collector layer formed above the electrolyte layer.

Features and advantages of the disclosed apparatus, systems, and methods will become apparent from the following description. Applicant is providing this description, which includes drawings and examples of specific aspects, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

Applicant's apparatus, systems, and methods provide an improved battery. The battery can be made by a method that includes the steps of providing an aluminum substrate; cold spraying cathode powder (such as Lithium nickel manganese cobalt oxide) onto said aluminum; cold spraying solid-state electrolyte powder onto said cathode layer; and cold spraying copper onto said solid-state electrolyte layer to make the battery.

The apparatus, systems, and methods are susceptible to modifications and alternative forms. Specific aspects are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific aspects of the apparatus, systems, and methods and, together with the general description given above, and the detailed description of the specific aspects, serve to explain the principles of the apparatus, systems, and methods.

FIG. 1 is an illustrative view showing a cold spray system for making a solid-state battery, according to one aspect.

FIG. 2A is a flow chart that illustrates a method of making a solid-state battery, according to one aspect.

FIG. 2B is a flow chart of operations of forming an active layer, according to one approach.

FIG. 3 is an illustrative view of a composite layer, according to one aspect.

FIG. 4 are images of a composite layer formed using cold spray technology, according to one aspect. Part (a) is an image of an aluminum substrate with a spray of a thin layer of composite material, part (b) a magnified image of the layer of particles from the thin layer of composite material depicted in part (a), part (c) a magnified image of an aggregate particle of the composite components from the layer of particles depicted in part (b).

FIG. 5 is an illustrative view a method of making a solid-state battery, according to another aspect.

FIG. 6 is an illustrative view of a method of making a single stack solid-state lithium battery with an anode layer, according to one aspect.

FIG. 7 is an illustrative view a method of making a multi-stack solid-state battery, according to one aspect.

FIG. 8 is a flow chart of a method of making a solid-state battery having a cylindrical cell configuration, according to one aspect.

FIG. 9 is an illustrative view of a method of making a cylindrical cell solid-state battery, according to one aspect. Part (a) illustrates nozzles of different powders for cold spraying, part (b) illustrates a method of making the battery, and part (c) illustrates a formed battery.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A nanoscale, nanoporous, etc. is defined as having a diameter or length (e.g., a pore having an average diameter) less than 1000 nanometers (nm). A microscale, microporous, micron-sized, etc. is defined as having a diameter or length (e.g., a pore having an average diameter) less than about 1000 microns (μm).

As used herein, the term “essentially” denotes an interval of accuracy that ensures a meaning of “mostly” but may not be exclusively 100%. The term “essentially” may denote 99.0% to 99.9%.

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred inventive aspects of a solid-state battery formed by using cold spray techniques and/or related systems and methods.

In one general aspect, an active layer for a battery includes a cold-sprayed composite layer positioned above a substrate, where the composite layer comprises an active component, a conductive component, and a binder. The composite layer is formed from a solid-state material.

In another general aspect, a method of making a composite layer includes forming a composite layer on a substrate by cold spraying particles of a composite powder above the substrate. The composite powder includes an active component, a conductive component, and a binder.

In yet another general aspect, a method of forming a solid-state battery having a cylindrical cell configuration includes rotating a substrate about the longitudinal axis of the substrate while the following layers are formed thereabove by cold spraying each of the layers: a composite layer comprising particles of a composite powder including an active component, a conductive component, and a binder, an insulator layer comprising particles of an insulator material powder, the insulator layer formed above a first portion of the composite layer, an electrolyte layer comprising particles of an electrolyte powder, the electrolyte layer formed above a second portion of the composite layer, wherein the first portion of the composite layer is different than the second portion of the composite layer, and a current collector layer comprising particles of a current collector material powder, the current collector layer formed above the electrolyte layer.

A list of acronyms used in the description is provided below.
3D three-dimensional
AM additive manufacturing
ASSLB All solid-state lithium battery
C Celsius
LiCoO₂ lithium cobalt oxide
LiPON lithium phosphorous oxynitride
LLZO lithium lanthanum zirconium oxide
nm nanometer
NMC nickel manganese cobalt
RT room temperature
SSB solid-state battery
SSE solid-state electrolyte
μm micron
W·h/kg watthour per kilogram
wt. % weight percent

Referring to the drawings, to the following detailed description, and to incorporated materials, detailed information about the apparatus, systems, and methods is provided including the description of specific aspects. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

Cold spray deposition has been widely established for the deposition of metals such as Cu, Al, Ni, as well as alloys thereof. High pressure gas is heated and passed through a flow-shaping nozzle to accelerate it to supersonic velocities, with powder being injected before or after the nozzle, depending on the precise design employed. The powders are typically spherical, with diameter from 20 to 70 microns (μm), though larger or smaller sizes may be employed depending on the application. Upon impact the particles deform and adhere to a substrate (if gas velocity is correctly chosen), with subsequent impacts adhering to this first layer.

In various aspects, a technology is described for the manufacture solid-state lithium battery of which all layers are comprised of a solid material and the layers are added by cold spray additive manufacturing technology. The high energetic forces of cold spray technology result in a particle impact on a substrate and/or previously deposited layers that causes deformation and/or interlocking of the particles. The process results in an extremely fast deposition of layers (e.g., greater than 100 μm/second) to form a solid-state battery having embedded compressive stress (without application of external applied stress). Moreover, the order of the layers, and the composition of each layer, may be defined by the application of the solid-state battery, and each layer may not be restricted by the functionality of the respective layer. Each layer of the solid-state battery is comprised of particles deposited by cold spray techniques onto a substrate and/or a previously deposited layer of particles.

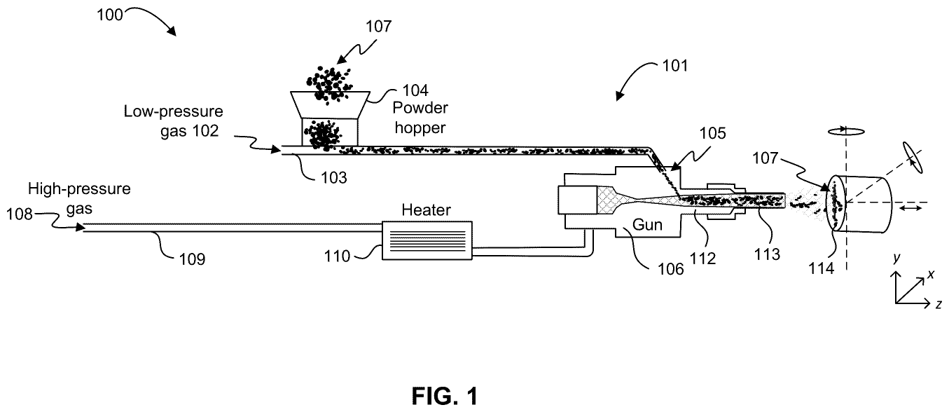

Referring to FIG. 1, an illustrative view shows a cold spray system 100 that may be used in a method of making a battery. The cold spray system 100 is a modified version of the cold spray apparatus disclosed in U.S. Patent Publication 2020/0157689 herein incorporated by reference. This versatile method of cold spray of brittle materials includes using a cold spray apparatus having a specific nozzle design and including a specific powder having a particles size mix that allows the deposition of materials previously considered incompatible with cold spray, including thermoelectric semiconductors or permanent magnets.

As illustrated in FIG. 1, components of the cold spray apparatus 101 include a low pressure gas feeder tube 103, a powder hopper 104, a spray gun portion 106, e.g., a convergent-divergent section, a high pressure gas feeder tube 109, a heater 110, and a nozzle 112.

In the cold spray system 100 may be operated as follows. The cold spray apparatus includes a gas feeder tube 109 that provides a high pressure gas 108 to flow through a heater 110. The high pressure gas 108 may include Ar, He, N₂, etc. The high pressure gas may be a mixture of gases. The heater 110 may heat the high pressure gas to a temperature in a range of room temperature (RT) to 625° C. The heated gas enters the spray gun portion 106 with narrow opening, then it exits the nozzle 112 through the extension piece 113 with super high speed (hundreds of meters per second). The high flow speed of the high pressure gas 108 in the spray gun portion 106 portion creates a vacuum near the powder feeding port 105 in the spray gun portion 106 thereby pulling in the powder 107 from the powder hopper 104. The spray gun portion 106 portion may also be referred to a nozzle, a head, etc. The high pressure gas may be considered the carrier gas that is driving the flow of the powder toward the substrate. A low pressure gas feeder tube 102 may be used to provide a low pressure gas to aid in the movement of the powder 107 from the powder hopper 104 to the spray gun portion 106 portion. In some approaches, a gas present in the hopper with the powder is mixed with the low pressure gas. In some approaches, the low pressure gas can be the same as the high pressure gas. Gas present in the powder feeder will be drawn into the system along with the powder to be sprayed. In some approaches a low pressure gas is included to push the powder into the high pressure gas. The low pressure may include Ar, N₂, air, etc. In preferred approaches, the low pressure gas includes Ar in order to avoid reactivity of the gas with the powder.

Inside the spray gun portion 106 portion, the movement of the powder 107 is accelerated by the high pressure carrier gas 108 and the powder 107 is sprayed onto the substrate 114. The high impact force densifies the sprayed powders onto the substrate and forms a dense layer. The substrate 114 may be moved during spray process in an x-direction or a y-direction in an x-y plane of the sample thereby forming a line, a surface pattern, etc. coating of the powder 107 on the substrate 114. In one approach, the sample may be moved in a z-direction that is perpendicular to the x-y plane to build thicker layers with subsequent depositions.

According to various aspects described herein, a method of the cold spray process includes a high pressure carrier gas (e.g., Ar, He, N₂, etc.) under a pressure of about 40 to 120 psi that flows through a heater (RT to 625° C.) and enters the spray gun with narrow opening, then it exits the nozzle with super high speed (330 to 1000 meters per second). The high flow speed created a vacuum near the powder feeding port in the spray gun and brings in the powders from the powder hopper. The powders get accelerated by the high pressure carrier gas and spray onto the substrate. The high impact force densifies the sprayed powders onto the substrate and forms a dense layer. By moving the substrate during spray process, a line or a surface pattern can be coated with the powders.

In one aspect, a solid-state battery (SSB) may be fabricated where all the layers have embedded compressive stress by cold spray additive manufacturing (AM). In one approach, an anode-free all solid-state lithium battery (ASSLB) may be fabricated using cold spray AM. In one approach, a cold spray method is described for forming SSBs that addresses the brittleness induced manufacturing difficulties. As described herein, the methods provide a low cost high product rate manufacture of anode-free ASSLBs with improved battery cycling performance. The advantages of the described cold spray method allows the manufacture of anode-free SSBs having the highest energy density as well as structural batteries having excellent load-bearing properties. In one approach, a solid-state battery having a cylindrical configuration may be fabricated using cold spray AM.

Further, an SSB fabricated using cold spray AM may be characterized as having embedded compressive stress such that the layers are added to the substrate by embedding the particles onto a substrate and/or previously deposited layer of particles using cold spray technology, and does not include external application of stress to form the layers. The components of the SSBs are mechanically constrained without application of external pressure during fabrication. The embedded compressive stress contributes to the mechanical integrity of the battery structure. Other conventional battery processing methods include a pressing step, e.g., a hydraulic pressure, for forming the layers, whereas the cold spray technique includes a forming layers without an added pressing step, the layers are compressed intrinsically using the cold spray technology.

In one aspect, a solid-state battery is a cold-sprayed structure that includes a series of layers that have the physical characteristic of a material cold-sprayed onto a substrate. The cold-sprayed layers (e.g., a coating of deposited particles) may be characterized by its composition, density, thickness, and geometry. A cold-sprayed layer includes deformed metal particles that are defined by an impact of the particles on the substrate and/or on previously deposited particles. For metal material, cold-sprayed particles have the physical characteristic of being deformed, and the deformation is caused by the impact of the metal particle deposited at supersonic speeds (e.g., greater than 100 μm/s under nozzle on a substrate or previously deposited particles). A cold-sprayed layer may have lower roughness, for example less than 10 μm root mean square (RMS). Some hard and/or brittle materials may include a non-metal binder to aid in the adhesion of the particles, or a non-metal additive to aid in the flow of the particles.

Cold spray of non-metal materials may have physical characteristics of having a microstructure that indicates interlocking of the non-metal particles caused by impact of the non-metal particles deposited at supersonic speeds on a substrate or previously deposited particles.

Cold spray of materials results in deposition of a range of materials where the materials are intermixed at the interface of the layers. The interface between adjacent layers may be characterized by particles of each layer embedded in the each of the layers. Particles being deposited onto the substrate and/or previously deposited particles may result in structural deformation of the particles, the substrate, and the previously deposited particles. The structural deformation of the particles results in the particles being adhered to the substrate and/or previously deposited particles. The impact of the particles deposited at supersonic speeds during cold spray results in a packing of the deposited particles and densification of the material in a layer on the substrate and/or the previously deposited layer of particles. The adhesion of the particles to the substrate as well as the continued adhesion and buildup of new deposited particles to the previously deposited material may form a solid-state of particles and substrate. In one approach, the successful initial and continued deposition may depend on the malleability of the particles.

Excellent adhesion to the substrate can be achieved with suitable choice of gas velocity and particle size. Because the adhesion is primarily mechanical, it is possible to join dissimilar materials such as ceramics and metals or semiconductors, and achieve high quality interfaces and bonding. Translating the nozzle with respect to the stage (or vice versa) enables large areas to be rapidly coated, as deposition rate can exceed 100 micron/s. Further, multiple passes can be made with different materials to rapidly assemble a layered structure that, such as a battery. Due to the extreme mechanical impact, the deposited powders may possess high dislocation density. Although it can be beneficial to certain glassy solid-state electrolytes, it may lower the ionic conductivity of LLZO based SSEs and the electrical conductivity of Al and Cu current collectors. To fine tune the performance of the sprayed battery, in situ laser or infrared heating may be applied after cold spray steps.

Physical characteristics of the materials, e.g., ductility, hardness, Young modulus, etc. contribute to the extent of densification of the deposited material by cold spray in terms of impact of the particles on the substrate and/or previously deposited particles. Physical characteristics of the particles of the material, e.g., particle size, shape distribution, etc. contribute to the extent of densification of the deposited material by cold spray. The cold spray conditions, e.g., gas temperature, gas pressure, velocity, etc. contribute to the extent of densification of the deposited material by cold spray. The density of a cold-spray layer (e.g., deposited coating) can be controlled by the gas pressure, heater temperature, powder characteristics (size, shape, chemistry).

In various approaches, the composition of the cold-spray layers is determined by feedstock powders. The following powders or powder mixtures may be used in the cold spray operations. In some approaches, an average diameter of particles for cold spray deposition may be in a range of 10 nanometers (nm) to 50 μm. In preferred approaches, an average diameter of particles for cold spray is less than about 20 μm and in exemplary approaches, an average diameter of particles for cold spray is in a range of 500 nm to 10 μm. In one example, particle size distribution may be in a range of 500 nm up to 5 μm. By using irregular particles of smaller size (<10 micron) it may be possible to achieve adhesion and deposition for less ductile particles through a mechanical interlocking and densification process. Particles impact and embed in the substrate and/or in prior deposited layers of particles due to their high kinetic energy and highly energetic state, with subsequent impacts densifying the initial impacts, then embedding themselves and building up the layer.

According to various aspects, all powders include particles having an average size in a range of 100 nm to about 50 μm, and preferably below 10 μm. In preferred approaches, powders of the battery components such as SSE, anode, etc. are particles having an average size preferably in a range of 20 nm to below 5 μm. In some approaches, materials such as polymers, sulfides, halides, etc. in particle form may be included.

A thickness of cold-sprayed layers (e.g., coating of deposited particles) may be controlled by the deposition times, substrate moving speed, gas pressure, heater temperature, powder characteristics, etc. and can be varying from 10 μm up to centimeters. A thickness of the current collector layers (Cu, Al, etc.) may be in a range of 1 μm to 15 μm. A thickness of a cathode layer may be in a range of 20 μm to 200 μm. A thickness of an SSE layer may be in a range of 10 μm to 100 μm. In various approaches, thinner Cu/Al/SSE layers and thicker cathode layers may result in higher energy density. For example, 1500 W·h/L volumetric energy density can be achieved with 10 μm thick Cu and Al layers, 100 μm thick NMC 811 cathode layers, and 50 μm thick SSE layers.

In various approaches, a geometry of cold-sprayed layers may be dependent on the geometry of the substrate, the masks that may be applied in front of the substrate, the substrate moving pattern, etc. Multilayers may be formed cold-spray AM layer by layer with options of varying materials in each layer, which allows the fabrication of a whole battery using the same technique.

As described herein for SSB applications, cold-spray powders may include anode current collector material (e.g., Cu), cathode current collector material (e.g., Al), anode active material for Li storage (e.g., Si, graphite, oxides, etc.), solid-state electrolyte (SSE) as ion conducting separator material (e.g., oxide-, halide-, sulfide-, polymer-based SSEs), cathode active material for Li storage (e.g., NMC, LiCoO₂, LiFePO₄, Li₂MnO₄, etc.), or a mixture of the these powders.

A current collector layer may include Cu and Cu-based single atom alloys or dilute alloys (Cu—Ag, Cu—Zn, Cu—Al, etc.). A current collector layer may enhance the wettability with metallic lithium and facilitate the formation of uniform lithium layer during the battery charging. Wettability refers to how well two materials make contact, e.g., there is lower surface energy between the materials. For liquids, droplets are flatter having a lower contact angle. For solid materials, the interface between the materials, e.g., quality the interconnecting bonds, may determine the extent of electrical and electrochemical contact between the materials. Al or Al alloy powders will be utilized to spray the cathode current collector layers.

In some approaches, an SSB may include an anode layer. The anode layer may include silicone, graphite, oxide, etc. The anode powder for cold spraying may include a binder, such as a polymer in the form of a powder for deposition via cold spray techniques. In one approach, the binder is primarily a polymer material.

In some approaches, an SSB includes an electrolyte layer that is a solid-state electrolyte layer (SSE). In one approach, an SSE powder for cold spray may include Li+ conducting ceramic powders. In one example, SSE powders may include oxide-based SSEs such as Li₇La₃Zr₂O₁₂ (LLZO) doped with Al, Ta, Nb, W, etc., lithium lanthanum titanate (LLTO), etc. In another approach, SSE powders may include halide-based SSEs such as Li₃InCl₆, Li₃YCl₆, Li₃ScCl₆, etc. In yet another approach, SSE powders may include sulfide-based SSEs such as Li₂S·P₂S₅. In some approaches, SSE powders may include a combination of oxide-based, halide based, and sulfide-based SSE powders. The resulting product may be a composite, multilayers, etc. The SSE layers may also include bilayers or multilayers of these SSEs to increase the stability with both metallic lithium and cathode materials. In some approaches, an SSE material may include binders, such as polymers in the form of a powder. As described elsewhere, the powders comprise particles having a size in a range of 500 nm to 50 μm.

In some approaches, an active layer of the battery may be a composite layer. In one approach, an active layer includes a cold-sprayed composite layer positioned above a substrate. The composite layer includes an active component, a conductive component and a binder. The composite layer is formed from a solid-state material. In one approach, the composite layer includes lithium. In one approach, the active layer is a cathode layer. In another approach, the active layer is an anode layer. In one approach, a composite cathode layer of a battery may include a composite of active materials, binder, and conductive additives.

In one approach for a cathode layer, the active component may include cathode active materials such as nickel, manganese, cobalt (NMC) cathode oxide powders, NMC lithium oxides, lithium iron phosphate, lithium cobalt oxides, lithium manganese oxides. For example, the active component may include NMC mixed with solid-state electrolytes, carbon black, etc., such as, NMC 811, NMC 622, NMC 532, NCA, LiCoO₂, LiFePO₄, etc. The active component may include other typical cathode materials that are generally known in the art.

In one approach for an anode layer, the active component may include anode active materials such as silicon, carbon, lithium, etc. The active component may include other typical anode materials that are generally well known in the art.

In one approach, the binder may include polymers (PVDF, cellulose, poly(acrylic acid), etc. and/or inorganic binders (Li₃BO₃, doped Li₇La₃Zr₂O₁₂, lithium halides, etc.). In preferred approaches, a binder is a non-metal binder that aids in deposition of brittle particles during cold spray AM.

In one approach, a conductive component may include carbon black, carbon nanotubes, carbon nanofibers, graphite, graphene, etc.

In some approaches, the composite layer may include solid-state electrolyte material. In one approach, the active component may include solid-state electrolyte material, (SSE). In some approaches, a composite layer that includes SSE may allow formation of a battery without a separate SSE layer. In other approaches, the presence of SSE in the composite layer may provide fast ion transport pathways.

In some approaches, a content of active materials (e.g., the active component( ) may be in a range of 70 wt. % to 99 wt. % of total content of the composite, a content of the combination of binders and conductive additives may be in a range of 1 wt. % to 30 wt. %.

In other approaches, the cold-spray AM process may be applied to Na, Al, Mg ion batteries using corresponding active materials and SSE materials.

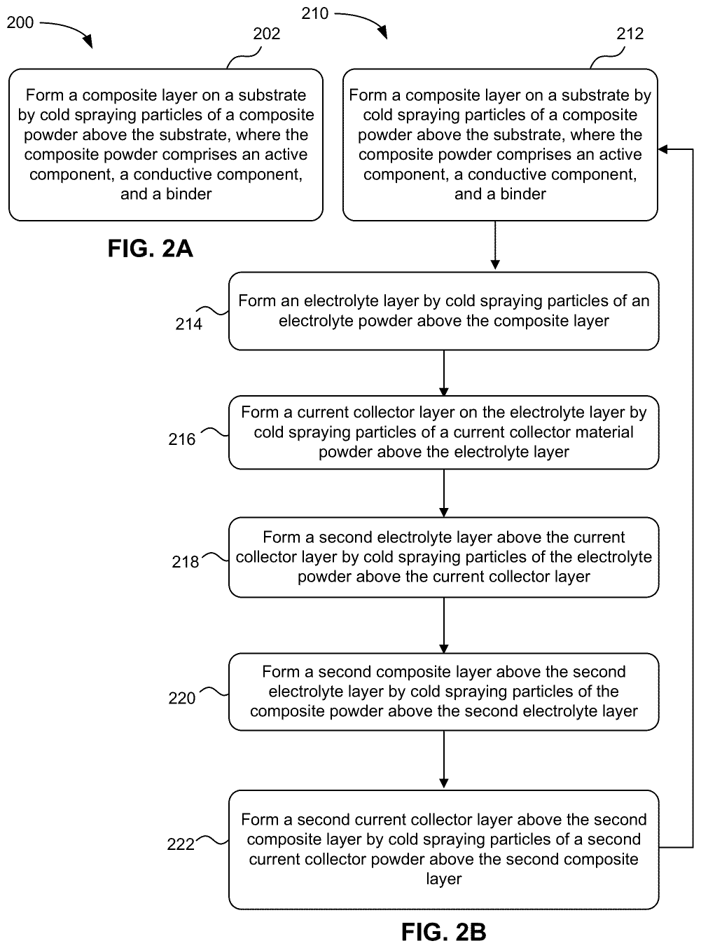

FIG. 2A illustrates a method 200 for forming an active layer using cold spray additive manufacturing techniques, in accordance with one aspect. As an option, the present method 200 may be implemented to construct structures such as those shown in the other FIGS. described herein. Of course, however, this method 200 and others presented herein may be used to form structures for a wide variety of devices and/or purposes which may or may not be related to the illustrative approaches listed herein. Further, the methods presented herein may be carried out in any desired environment. Moreover, greater or fewer operations than those shown in FIG. 2A may be included in method 200, according to various aspects. It should also be noted that any of the aforementioned features may be used in any of the approaches described in accordance with the various methods.

A method 200 of making an active layer may begin with operation 202 of forming composite layer on a substrate by cold spraying particles of a composite powder above the substrate. The composite powder may include an active component, a conductive component, and a binder. In one approach, the substrate may be an aluminum (Al) substrate. In another approach, the substrate may be a Cu substrate, e.g., starting from anode deposition. In one approach, the composite layer may include lithium nickel manganese cobalt oxide (NMC) cathode powders, e.g., NMC mixed with solid-state electrolytes, carbon black, etc. where the particles of these active material powders are cold sprayed onto the substrate.

The composite layer is formed from a solid-state material. Each of the components for forming the composite layer is a solid material in the form of a powder comprising a plurality of particles. The composite layer is not formed with a liquid such that the particles are not in a suspension of liquid.

In one aspect, a composite layer may be formed to provide multifunctionality in a layer of the SSB. In one approach, a composite layer may be formed to be added to a battery being formed by conventional techniques. In another approach, a composite layer may be formed to be included in a solid-state battery that is being formed by cold spray techniques.

A powder comprising a mixture of materials in particle form may be cold sprayed onto a substrate and/or previously deposited layer to impart multifunctionality in a layer. A composite layer may aid in deposition of materials and subsequent layers. In some approaches, a composite layer may enhance properties of the materials and the battery. For example, a composite layer may enhance mechanical properties by improving stability/ductility. Moreover, a composite layer may enhance the electrical and ionic conductivity thereby improving the rate/performance to the battery reactions. In one approach, a composite material may include three components such a component comprising the active material, a component for supplying electrons, and a component that functions as a binder. For example, a composite layer may be formed from a mixture of a cathode material that includes Li (the active material), carbon black (the component that supplies electrons, and a polymer (the binder). Including a polymer as the binder allows the polymer to bind the active materials with carbon and current collector in the electrode layer. In one approach, a polymer may be present in an electrolyte separator layer. The solid-state electrolyte layer between anode and cathode is an ion conducting separator layer in the battery, which separates anode and cathode and prevents short circuit. A polymer may function to bond solid-state electrolyte materials in the electrolyte separator layer.

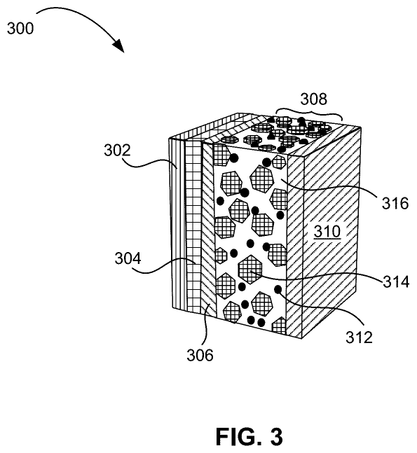

As illustrated in FIG. 3, one example of a SSB 300 includes a composite layer 308. The SSB 300 includes a current collector layer 302 comprising copper, a Li layer 304, and a solid electrolyte layer 306 comprising Li₃InCl₆. A substrate 310 may include aluminum. The composite layer 308 may be positioned between the solid electrolyte layer 306 and the substrate 310. For example, a composite layer 308 may include carbon black 312 to improve conductivity, the active material 314, and a solid-state electrolyte material 316. The composite layer 308 may be deposited by cold spray onto an aluminum substrate 310. In one approach, the solid-state electrolyte material 316 may include polymer binder to help adhesion of the composite layer 308 to the substrate 310. The composite layer may include a cathode material typically used in cathode electrodes of batteries such as NMC, etc. In addition, the cathode material may include Li, but may not be limited to Li and also may include Na, Mg, Al, etc.

The amounts of each component of the composite mixture, adding up to 100%, may include over 80 to 95% of active component, and for each of the binder component and electron supplying component the amount may be greater than 5% to 10% of each component. For example, 80% of active material, 10% of binder, and 10% of carbon. The composition may be adjusted by changing amount of binder content and carbon black and the balance of active component. This configuration may be used for the conventional Li ion battery.

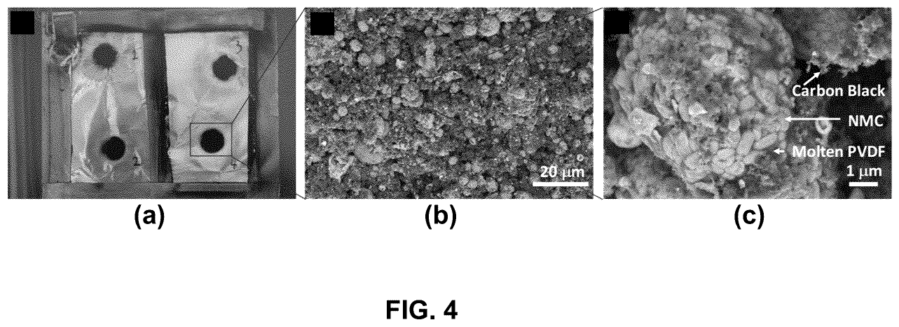

In one example, a composite layer of cathode material, carbon black, and polymer binder may be cold sprayed onto an aluminum substrate. As depicted in FIG. 4, a composite mixture of NMC811, a cathode material, carbon black, and PVDF polymer was directed onto an aluminum substrate using cold spray technology. These images represent an example only and are not meant to be limiting in any way. Part (a) is an image of an aluminum substrate with a spray of a thin layer of composite material, part (b) a magnified image of the layer of particles from the thin layer of composite material depicted in part (a), part (c) a magnified image of an aggregate particle of the composite components from the layer of particles depicted in part (b).

In one approach, the mixture of the composition may include defined portions of each component as a powder in a mixture that is added to the powder hopper of the cold spray apparatus. Particles of each component are present in the gas stream in amounts proportional to the amounts in the mixture and the particles are simultaneously into the gas stream to be directed to the substrate as a mixture of particles. In another approach, two components may be combined before addition to the third component for forming a powder mixture in the powder hopper. For example, particles of the binder materials are adhered to the surface of the active component, e.g., NMC, such that a combined particle of NMC:binder is added to the particles of carbon black (e.g., the electron supplying component) such that the pressurized gas stream directs a composite mixture of NMC:binder with carbon black particles toward the substrate for forming a composite layer.

For solid-state batteries, the composite mixture may include a combination of the active component (e.g., NMC) particles, solid-state electrolyte particles (e.g., Li₃InCl₆), electrically conductive additive particles (e.g., carbon black), and possibly binder additive particles (e.g., PVDF).

FIG. 2B illustrates a method 210 for forming solid-state battery using cold spray additive manufacturing techniques, in accordance with one aspect. As an option, the present method 210 may be implemented to construct structures such as those shown in the other FIGS. described herein. Of course, however, this method 210 and others presented herein may be used to form structures for a wide variety of devices and/or purposes which may or may not be related to the illustrative approaches listed herein. Further, the methods presented herein may be carried out in any desired environment. Moreover, greater or fewer operations than those shown in FIG. 2B may be included in method 210, according to various aspects. It should also be noted that any of the aforementioned features may be used in any of the approaches described in accordance with the various methods.

Method 210 may begin with operation 212 of forming an active layer as described in operation 202 of method 200. The active layer may be a composite layer. In some approaches, the active layer formed in operation 212 is a cathode layer. In one approach, the composite layer may include SSE component. In another approach, the composite layer may include organic additive components. In one approach, an active layer may include a cathode layer, an SSE layer, and a layer of organic additives layers. In another approach, an active layer includes a cathode layer and layer of organic additive layers (without an SSE layer).

Operation 214 includes forming an electrolyte layer by cold spraying particles of an electrolyte powder above the active layer. The electrolyte powder includes a solid-state electrolyte (SSE) powder.

After forming the electrolyte layer on the composite layer, operation 216 includes forming a current collector layer on the electrolyte layer by cold spraying particles of a current collector material powder above the active layer. This approach may be used for forming an anode-free battery configuration. In various approaches, intervening layers may be formed by cold spraying to add said intervening layer between the layers, accordingly “onto” may mean directly onto or thereabove.

Single Stack Solid-State Anode-Free Lithium Battery

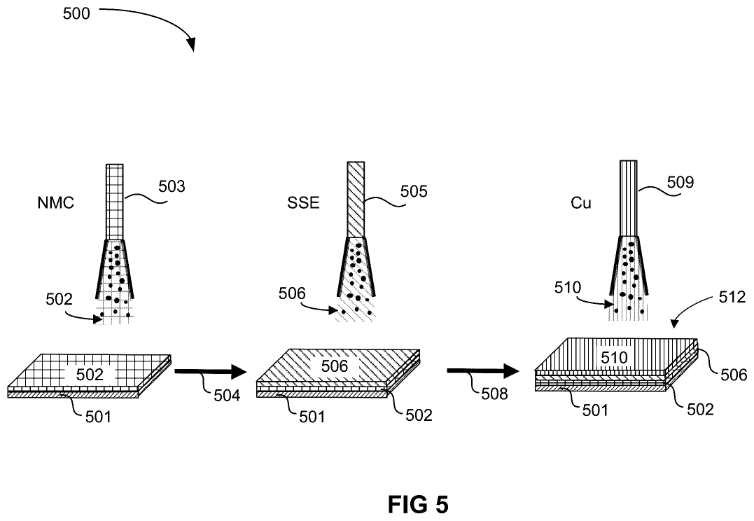

In one approach, a solid-state battery formed with operations 212 to 216 of method 210 (FIG. 2B) may be a single stack solid-state battery with Li-anode-free design. FIG. 5 illustrates one example of a single stack solid-state anode-free lithium battery 512.

The method 500 begins with an aluminum substrate 501. The method begins with a nozzle 503 with a cathode powder hopper containing a cathode powder for forming a cathode layer 502, e.g., lithium nickel manganese cobalt oxide (NMC) powder, that provides particles of the cathode powder for forming a cathode layer 502 to be cold sprayed the onto the aluminum substrate 501.

The next operation 504 includes moving the substrate 501 under another nozzle 505 with SSE powder hopper. In some approaches, in order to minimize cross-contamination between the materials of each layer, each layer is formed using a separate nozzle to cold spray a specific powder material onto the substrate. For example, as depicted in FIG. 5, nozzle 503 directs a gas stream of cathode material for forming the cathode layer 502 (e.g., NMC particles), nozzle 505 directs a gas stream of SSE particles for forming an SSE layer 506, and nozzle 509 directs a gas stream of Cu particles for forming a current collector layer 510. Nozzle 503 for directing a gas stream of cathode material particles for forming the cathode layer 502 is different than a nozzle 505 for directing a gas stream of SSE particles for forming an SSE layer 506. In one approach, the multiple distinct nozzles are positioned adjacent to each other, and each nozzle sprays its respective particles in a predefined order to form layers on a substrate. In another approach, each layer is formed on the substrate and subsequent layers by moving the deposition substrate with each layer to a different unit having a nozzle for directing a gas stream of the respective particles.

In another approach, where cross-contamination between the materials is allowable, a nozzle may be employed to direct a series of gas streams in sequence where each gas stream includes a different population of particles. For example, one nozzle directs particles of a cathode powder, e.g., NMC, onto a substrate, and the nozzle is subsequently used to direct particles of an SSE power onto a substrate. A potential drawback may be cross-contamination between the materials that are cold sprayed into layers on the substrate.

A layer of SSE on the cathode layer is formed by cold spraying the SSE powder for forming an SSE layer 506 onto the cathode layer comprised of particles of cathode powder for forming the cathode layer 502. The substrate 501 is moved 508 under a nozzle 509 to spray Cu particles. Particles of the current collector powder (e.g., Cu) for forming a current collector layer 510 are cold sprayed onto the SSE layer of SSE particles from the SSE powder for forming an SSE layer 506.

In one aspect, a solid-state battery includes a substrate layer, a cold-sprayed active layer positioned above the substrate layer, and a cold-sprayed current collector layer positioned above the active layer. Each of the layers is formed from a solid-state material. There is no solvent present in the process of forming the layers. Each layer is formed from a powder having a solid form. In some approaches, the active layer includes lithium. In one approach, the active layer includes a cold-sprayed cathode layer and a cold-sprayed electrolyte layer.

In various approaches, a Li metal may be added as an anode for the battery. In one approach, an SSB having a Li rich cathode, e.g., NMC, LiFePO₄, etc., may not include anode material. By removing the anode layer, the energy density may be significantly increased in the SSB. Some battery configurations may have an anode-free configuration. In one example, Cu may be used as a current collector without any other materials between the SSE layer and the Cu layer. In another example, interfacial layer may be added between SSE layer and Cu layer to tune the lithium plating/stripping behaviors.

In one example, as illustrated in FIG. 5, single stack solid-state anode-free Li battery 512 includes an Al substrate 501, a cathode layer 502 cold-sprayed above the Al substrate 501, an SSE layer 506 cold-sprayed above the cathode layer 502, and a current collector layer 510 cold-sprayed above the SSE layer 506.

Single Stack Solid-State Lithium Battery with Silicon Anode

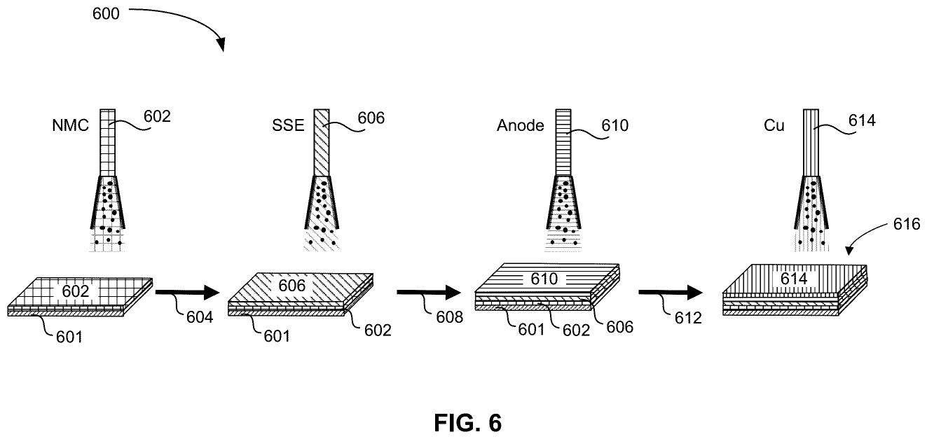

In one aspect, a solid-state lithium battery having an anode layer may be fabricated. Referring now to FIG. 6, an illustrative view of yet another aspect of a method of forming a battery. According to one aspect, a method is disclosed of forming a single stack solid-state lithium battery with an anode layer. The anode layer may include silicone, graphite, oxide, etc. In one approach the anode layer may be added using similar technique of cold spraying particles of anode powder onto a layer of the battery. In one approach, the method of forming a lithium battery with an anode layer includes some of the operations of method 210, FIG. 2B, and further includes, before forming the current collector layer, forming an anode layer by cold spraying particles of an anode powder above the SSE layer.

In some approaches, the anode powder may include graphite, silicon, oxide, etc. In another approach, an anode layer may be attached following formation of the solid-state battery using cold spray techniques as described herein.

In one example, a method 600 as illustrated in FIG. 6 includes cold spraying particles of a cathode powder for forming a cathode layer 602 (e.g., lithium nickel manganese cobalt oxide powder) onto an Al substrate 601. In one approach, the cathode powder may be a composite of active materials (e.g., NMC) mixed with solid-state electrolytes, carbon black, binder, etc. The substrate 601 is moved 604 under another nozzle with a hopper containing SSE powder for forming the SSE layer 606, and particles of the SSE powder for forming an SSE layer 606 are cold sprayed onto the cathode layer 602. The substrate 601 is moved 608 under a nozzle with a hopper containing anode powder for forming the anode layer 610 (e.g., silicon, any known anode material, etc.), and particles of the anode powder for forming the anode layer 610 are cold sprayed onto for the SSE layer 606. The substrate 601 is moved 612 under a nozzle with a hopper containing the current collector powder (e.g., Cu) for forming a current collector layer 614, and particles of the current collector powder are cold sprayed onto the anode layer 610 to form a current collector layer 614.

In one aspect, as illustrated in FIG. 6, a single stack solid-state lithium battery with silicon anode 616 is formed using a cold spray AM techniques. In one approach, the anode layer is positioned above the electrolyte layer, the electrolyte layer being in the solid form.

In one approach the substrate may be Cu, and the order of the operations may be reversed and cold sprayed in the following order: Cu, anode layer, SSE layer, cathode layer, Al layer.

In one approach, an anode layer may be added to the SSB after fabrication of the formed SSB. Examples of an anode material added to the solid-state battery include graphite, silicone anode, etc.

In one aspect, a multi-layer SSB may be fabricated using cold spray AM techniques. In one approach, a method includes a starting Al current collector (e.g., a substrate), followed with cold sprays of a cathode layer, a solid-state electrolyte (SSE) layer, a Cu layer, SSE layer, cathode layer, and Al layer. In another approach, a multi-layer SSB includes a starting Cu current collector (e.g., substrate), followed with cold sprays of SSE, cathode, Al, cathode, SSE, and Cu layers. In some approaches, an anode layer may not be included thereby dramatically increasing the energy density of the whole battery.

Multi-Stack Solid-State Lithium Batteries

In various aspects, a method forms a multi-layer multi-stack battery manufactured by a series of cold-spray procedures. In one approach, a multi-layer multi-stack batteries has a pouch cell configuration. In another approach, a multi-layer multi-stack batteries has a cylindrical-cell configuration. Each multi-layer set in the multi-stack battery includes Al and Cu current collector layers. In one approach, a current collector layer may have the same composition as the substrate. In one approach, a current collector layer may have a different composition than the substrate. In one example, a multi-layer set may include a current collector layer having an Al composition and another current collector layer having a Cu composition.

In some approaches of forming a flat pouch cell, an external pressure may be applied during operation. A flat pouch cell may deliver higher packing density. In another approach, a cylindrical cell is formed without additional external pressure during operation. The final layer of a cylindrical cell may be a protective/containment layer that tends to partially provide pressure during operation. Internal stresses generated during operation may be absorbed by inserting cushion layers in between the repeating unit layers. Cushion layers may be porous electrodes, current collectors, etc.

In one aspect, a solid-state battery includes multiple sets of layers with each set of layers including Al-cathode-SSE-anode-Cu layers. A multi-stack solid-state battery includes a series of sets of layers and each set of layers includes Al-cathode-SSE-anode-Cu layers. If a series of layers such as Al-cathode-SSE-anode-Cu-anode-SSE-cathode-Al-cathode as a deposition cycle is adopted, all Cu layers preferably are connected at one end and all Al layers are preferably connected at another end to for multi-stacked low voltage, high current cells by parallel connections. Alternatively, if a series such as Al-cathode-SSE-anode-Cu—Al-cathode as a deposition cycle is adopted, no additional interlayer connections are needed—forming a high voltage cell by series connections. Without wishing to be bound by any theory, it is believed that a unit of multi-layers that includes one Al and one Cu current collectors in addition to the anode, separator, and cathode layers is essential for an efficient solid-state battery to conduct electrons and for fabrication of a functional multi-stack battery pack.

Referring back to FIG. 2B, the method 210 of forming a solid-state battery may be continued to include further operations to form a multi-stack solid-state battery. After operations 212 to 216, operation 218 includes forming a second electrolyte layer above the current collector layer by cold spraying particles of the electrolyte powder above the current collector material. The electrolyte powder may be SSE. The electrolyte powder for providing particles to be cold sprayed to form the second electrolyte layer may be the same electrolyte powder used for particles cold sprayed onto the substrate (i.e., the first electrolyte layer).

Operation 220 includes forming a second composite layer above the second electrolyte layer by cold spraying particles of the composite powder above the second electrolyte layer. In one approach, the second composite layer may include particles from a same type of composite powder used to cold spray the first composite layer. In one approach, the second composite layer may have a different composition than the first composite layer cold sprayed on the substrate. In one approach, the second composite layer may be a cathode layer.

Operation 222 includes forming a second current collector layer above the second composite layer by cold spraying particles of a current collector powder above the second electrolyte layer. In one approach, the powder used to form the substrate may be the same composition as the current collector powder. In one approach, the composition of the first current collector layer may be the same as the composition of the second current collector. The substrate and/or current collector powder may include Cu, Al, etc. In one approach, the second current collector layer may be a capping layer. In one approach, the composition of the capping layer is the same composition as the substrate. In another approach, the capping layer may be a conventional packaging material for commercial batteries.

The series of operations 212 to 222 of method 210 form a multi-layer solid-state battery. In one aspect, a multi-stack solid-state battery may be formed by performing at least two sequences of at least some of the operations 212 to 222 of method 210 in the same order.

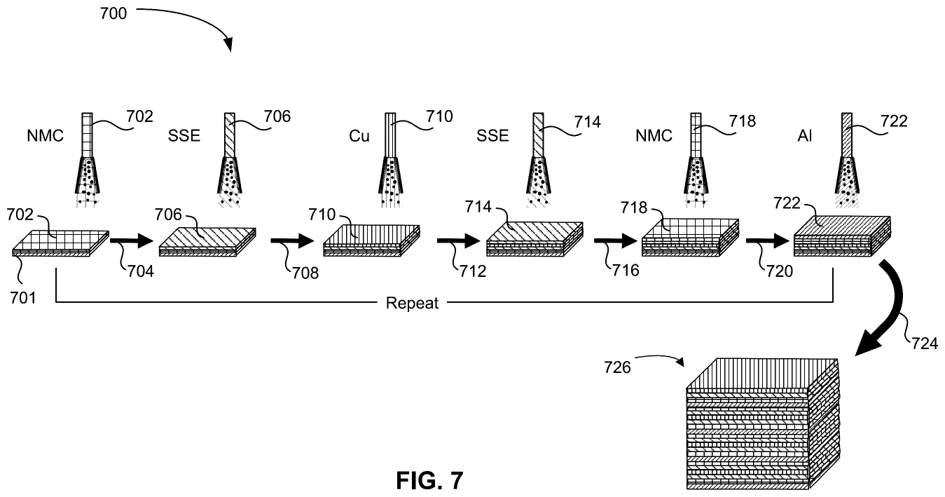

In one example, referring now to FIG. 7, an illustrative view of a method of forming a multi-stack solid-state battery includes starting with an Al substrate 701, a cathode powder for forming the cathode layer 702 (e.g., NMC) is cold sprayed onto the Al substrate 701. The substrate 701 is moved 704, and an SSE powder for forming the SSE layer 706 is cold sprayed onto the cathode layer 702. The substrate 701 is moved 708, and a current collector powder for forming the current collector layer 710 (e.g., Cu) is cold sprayed onto the SSE layer 706. The substrate 701 is moved 712, and a second SSE powder for forming the second SSE layer 714 is cold sprayed onto the current collector layer 710. The substrate 701 is moved 716, and a second cathode powder for forming the second cathode layer 718 is cold sprayed onto the second SSE layer 714. The substrate 701 is moved 720, and a second current collector powder for forming the second current collector layer 722 (e.g., Al) is cold sprayed onto the second cathode layer 718.

As illustrated, the operations of cold spraying the series of layers 702 to 722 may be repeated 724 until the desired number of stacks (i.e., each stack is one series of layers) are formed. The method 700 forms a multi-stack solid-state battery 726, in which each set of layers includes a current collector layer. The multi-stack solid-state battery 726 may be a lithium anode-free battery.

In one approach, the substrate 701 may be Cu, and the method begins with anode deposition. Preferably, Cu is a material used for an anode and Al is a material used for a cathode. In various approaches, an anode may be comprised of different materials, alloys, etc. that are known in the art for forming an anode. In various approaches, a cathode may be comprised of different materials, ceramic composites, etc. that are known in the art for forming a cathode. In one approach, where the substrate is comprised of Cu, a composition of the layers is similar but in reverse of the order applied for a substrate comprised of Al. In one example, an order of layers may be Cu-anode-SSE-cathode-Al-cathode-SSE-anode-Cu-anode—having a parallel connection for low voltage configuration. In another example, an order of layers may be Cu-anode-SSE-cathode-Al—Cu-anode—having a series connection for high voltage configuration.

In some approaches, a battery may be formed using multiple different materials, e.g., a cathode material NMC (1), an SSE material (2), a current collector material Cu (3), and a substrate material Aluminum (4). In various approaches, the order of the layers may determine the type of cell battery formed. In one approach, a battery may be formed that includes an alternating layers, such as a double-sided battery (e.g., 1-2-3-2-1). For example, as shown in FIG. 7, on both sides of the copper (3) layer 710, an SSE (2) layer 706, 714 is adjacent the copper (3) layer 710, and both sides of the aluminum (4) layer 722, a NMC (1) layer 718, 702 is adjacent the aluminum (4) layer 722. The layers may be connected in parallel, a small voltage battery with a high current because the cells are connected in parallel. In another approach, the order may be arranged in series according to a high voltage cell battery (e.g., 1-2-3-4-1-2-3-4).

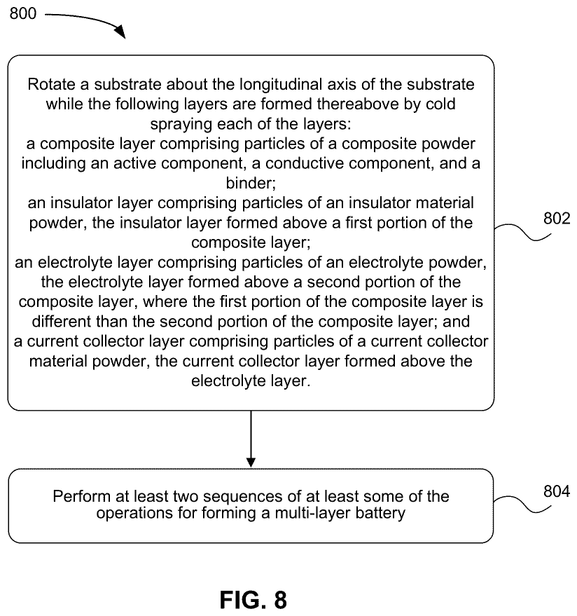

FIG. 8 illustrates a method 800 for forming a solid-state battery having a cylindrical cell configuration using cold spray additive manufacturing techniques, in accordance with one aspect. As an option, the present method 800 may be implemented to construct structures such as those shown in the other FIGS. described herein. Of course, however, this method 800 and others presented herein may be used to form structures for a wide variety of devices and/or purposes which may or may not be related to the illustrative approaches listed herein. Further, the methods presented herein may be carried out in any desired environment. Moreover, greater or fewer operations than those shown in FIG. 8 may be included in method 800, according to various aspects. It should also be noted that any of the aforementioned features may be used in any of the approaches described in accordance with the various methods.

Method 800 of forming a solid-state battery having a cylindrical cell configuration includes operation 802 of rotating a substrate about (e.g., around, in a circular fashion, etc.) the longitudinal axis of the substrate. The substrate may include a wire, a tube, a rod, etc. The substrate may include Al, Cu, etc. While the substrate is rotated, the following layers are formed thereabove by cold spraying each of the layers:
a composite layer that includes particles of a composite powder including an active component, a conductive component, and a binder,
an insulator layer that includes particles of an insulator material powder, the insulator layer is formed above a first portion of the composite layer;
an electrolyte layer that includes particles of an electrolyte powder (e.g., SSE powder), the electrolyte layer is formed above a second portion of the composite layer, where the first portion of the composite layer is different than the second portion of the composite layer, and
a current collector layer that includes particles of a current collector material powder, the current collector layer is formed above the electrolyte layer.

In one approach, additional layers may be cold sprayed to form the following layer above the current collector layer:
a second electrolyte layer that includes particles of the electrolyte powder, the second electrolyte layer is formed above the current collector layer,
a second composite layer that includes particles of the composite powder, the second composite layer is formed above the second electrolyte layer, and
a second current collector layer that includes particles of a powder, where the powder has the same compositions as the substrate.

In one approach, the second current collector layer may be a capping layer that is a final layer of a battery stack. The capping layer may function as a final external packaging layer to avoid air exposure. For multi-stack battery design, the layer on the second composite layer of a multi-layer stack may be a second current collector layer, thus, an additional multi-layer stack may be deposited on the second current collector layer to form a multi-stack battery design. In various approaches, there may be two different current collector layers for anode and cathode, respectively.

The composite layer may be a cathode layer. In one approach, the cathode layer may be comprised of one material. In one approach, the cathode layer is not a composite layer. Although possible, a cathode layer comprised of a series of layers, such as, one layer being an active material, a second layer being an SSE material, a third layer being a conductive material, etc., would not be a good design for a battery because it would be unlikely to form the intermixing that is beneficial for a battery.

For some of the layers, a portion of the layer may be formed above the substrate and/or previously formed layer. The dimensions of the portion may be predefined according to a model of the geometry of the battery. The cold spray AM process allows defined dimensions of a layer formed during deposition of particles according to a predefined pattern.

An insulator layer may be included as a layer in a cylindrical cell configuration in order to avoid shorting between susceptible layers, e.g., Al substrate layer and a Cu current collecting layer. Powders for an insulator layer may include ceramics such as Al₂O₃, yttria-stabilized zirconia, etc. In another approach, an insulator layer may include a polymer (e.g., PVDF, PTFE, polyimide, etc.) that forms a thicker non-conducting layer.

In one approach, forming a multi-stack solid-state battery in a cylindrical cell configuration includes operation 804 of method 800 of performing at least two sequences of at least some of the operations of operation 802 in the same order.

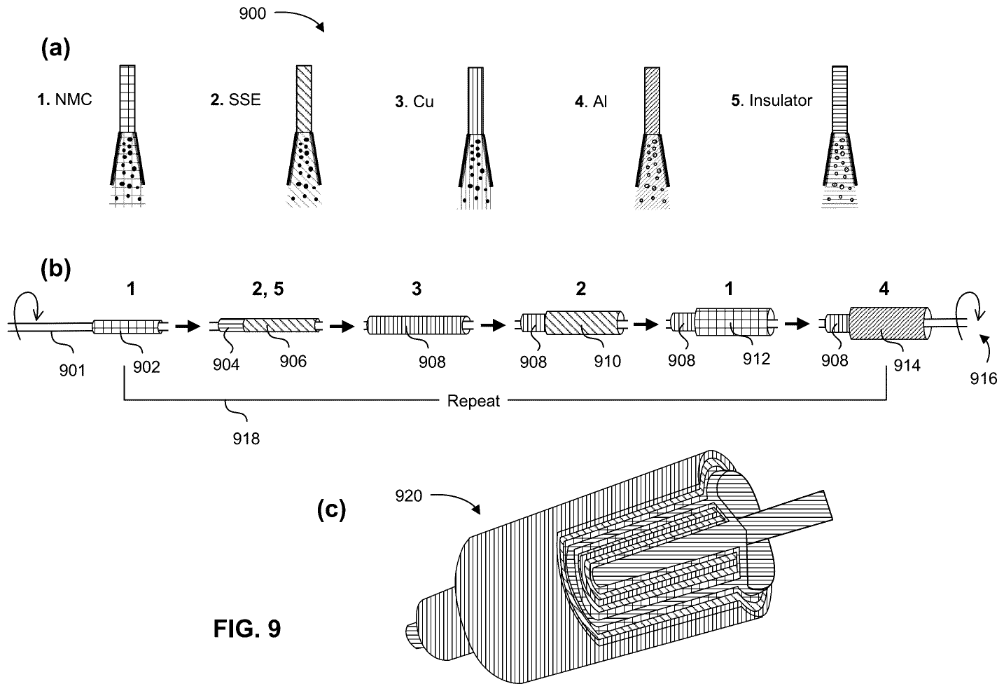

Referring now to FIG. 9, part (b) is an illustrative view of a method 900 making a battery having a cylindrical cell configuration, according to one aspect. Method 900 of forming a battery having a cylindrical cell configuration is one example only, and is not meant to be limiting in any way. Part (a) illustrates five nozzles that provide powders for the cold spray: (1) cathode powder (e.g., NMC), (2) SSE, (3) current collector powder (e.g., Cu), (4) a powder used for a substrate (e.g., Al), and (5) insulator powder. The apparatus for cold spraying a battery having a cylindrical cell configuration includes a device 916 for rotating the substrate 901 (e.g., Al wire).

As illustrated in part (b), a substrate 901, e.g., an Al wire, is rotatable, and a cathode powder for forming a cathode layer 902 (e.g., Ni, Mn, Co (NMC) cathode powders (or NMC mixed with solid-state electrolytes, carbon black, etc.)) is cold sprayed onto the substrate 901 that is rotated. An insulator powder for forming an insulator layer 904 is cold sprayed onto a portion (e.g., at one end) of the cathode layer 902 that is rotated. A battery having a cylindrical cell configuration includes an insulator material to prevent shorting between the materials such as aluminum and copper.

An SSE powder for forming an SSE layer 906 is cold sprayed onto a second portion of the cathode layer 902, where the second portion is different than the first portion of the cathode layer 902. For example, the insulator layer 904 is cold sprayed at one end of the cathode layer 902 and the SSE layer 906 is cold sprayed at the opposite end of the cathode layer 902. The cathode layer 902 is rotated during cold spraying of the insulator layer 904 and the SSE layer 906.

A current collector layer 908 (e.g., Cu) is cold sprayed onto the SSE layer 906 that is rotated. A second SSE layer 910 is cold sprayed on the current collector layer 908 that is rotated. A second cathode layer 912 is cold sprayed on the second SSE layer 910 that is rotated. A second current collector layer 914 (e.g., Al) is cold sprayed onto the second cathode layer 912 that is rotated.

A multi-stack battery in a cylindrical cell configuration may be formed by repeating 918 the operations of method 900 in the same order.

In one aspect, a cold spray AM method as described herein forms a multi-layer solid-state battery having a cylindrical cell configuration. In one example, as illustrated in part (c) of FIG. 9, an SSB having a cylindrical cell configuration 920 is formed using method 900 of part (b).

The wire or substrate for cold spray can also be arbitrary shape other than flat plate or rod. Cold spray can be applied to 3D surfaces of an object, allowing the battery to be closely incorporated into the product design. For example, the battery can be cold sprayed onto a vehicle (door panels, hood, platform, trunk, etc.), an aircraft, a LED display, etc. The solid-state battery with high modulus and strength can replace part of the structural materials in those product, making the whole product lighter and more powerful. The achieve the free cold-spray on arbitrary shapes, either the object will be loaded on a platform that can translate/rotate freely, or the nozzle will be motorized to spray with controlled distance and angle.

The process of cold process of forming a solid-state battery having decompressive stress points potentially overcomes the tensile stress-induced cracking that is demonstrated in conventional batteries in which the layers that have been fabricated using externally applied pressing step. In conventionally-fabricated solid-state batteries, adhesion (typically created by externally applied pressure) between the cathode and electrolyte layers fail during bending of the battery and demonstrate the formation of cracks that form are typically characterized as interfacial delamination.

Cold spray deposition of adjacent layers having different materials minimizes failure of the regions of different materials during bending and tends to overcome interfacial delamination. The particles of the different materials embed into each other and thus there is a narrow transition region between the materials that minimizes any possible interpenetration between the two materials and the formed battery is resistant to interfacial delamination during application of contact forces (e.g., bending).

Moreover, cold spray techniques of forming layers of solid-state batteries allows intrinsic densification of different materials (e.g., embedded particles on contact) that therefore results in sufficient solid-solid contact between the solid layers of different materials. In sharp contrast, conventionally fabricated solid-state batteries need external force (e.g., hydraulic press) to form the contact between layers of different materials. However, the applied force to densify the different solid layers of material may be insufficient for consistent solid-state contact between the materials thereby resulting in a potentially large internal resistance and deterioration of performance of the battery.

In one aspect, the process of cold spray layers of the battery may be used for dry fabrication of a conventional ionic battery. For example, a composite layer may be formed using cold spray techniques of directing particles form a powder mixture of components for the composite layer (e.g., active material, carbon supplying material, and binder), and then the layer may be added to a battery obtained by conventional manufacturing methods.

For a solid-state battery, the cathode material may be configured to add solid-state electrolyte material materials, e.g., Lithium halide materials, Li sulfide materials, oxide-based solid-state electrolyte materials. These materials typically have high ionic content compared to the NMC cathode materials and they serve as similar role like the Li ions.

Therefore, it will be appreciated that the scope of the present application fully encompasses other aspects which may become obvious to those skilled in the art. In the claims, reference to an element in the singular is not intended to mean “one and only one” unless explicitly so stated, but rather “one or more.” All structural and functional equivalents to the elements of the above-described preferred aspect that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific aspects have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

In Use

Various aspects of an inventive concept described herein may be used for the manufacture of solid-state batteries.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed is:

1. An active layer for a battery, comprising:
a cold-sprayed composite layer positioned above a substrate,
wherein the composite layer comprises an active component, a conductive component, and a binder,
wherein the composite layer is formed from a solid-state material.

2. The active layer as recited in claim 1, wherein the composite layer includes lithium.

3. The active layer as recited in claim 1, wherein the active component includes at least one material selected from the group consisting of: lithium, nickel, manganese, cobalt, cobalt oxides, lithium iron phosphate, lithium cobalt oxides, lithium manganese oxides, carbon, silicon, and a combination thereof.

4. The active layer as recited in claim 1, wherein the binder is a non-metal binder selected from the group consisting of: an organic polymer and an inorganic binder.

5. The active layer as recited in claim 1, wherein the conductive component is selected from the group consisting of: carbon black, carbon nanotubes, carbon nanofibers, graphene, and graphite.

6. The active layer as recited in claim 1, further comprising a solid-state electrolyte material.

7. The active layer as recited in claim 1, wherein the composite layer is an anode layer.

8. The active layer as recited in claim 1, wherein the composite layer is a cathode layer.

9. A solid-state battery, comprising:
the active layer as recited in claim 1; and
a cold-sprayed current collector layer positioned above the composite layer.

10. The solid-state battery as recited in claim 9, wherein the solid-state battery comprises a cold-sprayed electrolyte layer positioned between the composite layer and the current collector layer.

11. The solid-state battery as recited in claim 10, further comprising, an anode layer positioned above the electrolyte layer.

12. The solid-state battery as recited in claim 10, further comprising:
a cold-sprayed second electrolyte layer positioned above the current collector layer;
a cold-sprayed second composite layer positioned above the second electrolyte layer; and
a cold-sprayed second current collector layer positioned above the second composite layer.

13. The solid-state battery as recited in claim 12, wherein a shape of the solid-state battery is a cylindrical cell configuration.

14. A multi-stack solid-state battery, comprising at least two repeating sets of at least some of the layers as recited in claim 12.

15. A method of making a composite layer, the method comprising
forming a composite layer on a substrate by cold spraying particles of a composite powder above the substrate,
wherein the composite powder comprises an active component, a conductive component, and a binder.

16. The method as recited in claim 15, wherein an average size of the particles is in a range of greater than 100 nanometers to less than 50 microns.

17. The method as recited in claim 15, wherein the substrate comprises a material selected from the group consisting of: aluminum and copper.

18. The method as recited in claim 15, wherein the composite powder further comprises a solid-state electrolyte material.

19. A method of making a solid-state battery, the method comprising:
forming the composite layer as recited in claim 15; and
forming an electrolyte layer by cold spraying particles of an electrolyte powder above the composite layer; and
forming a current collector layer on the composite layer by cold spraying particles of a current collector material powder above the electrolyte layer.

20. The method as recited in claim 19, wherein the current collector material powder comprises a material selected from the group consisting of: copper, copper-based single atom alloys, and dilute alloys.

21. The method as recited in claim 19, further comprising:
before forming the current collector layer, forming an anode layer by cold spraying particles of an anode powder above the composite layer.

22. The method as recited in claim 21, wherein the anode powder comprises a material selected from the group consisting of: graphite, silicon, and an oxide.

23. A method of forming a multi-layer solid-state battery, the method comprising, forming the battery as recited in claim 19;
forming a second electrolyte layer above the current collector layer by cold spraying particles of the electrolyte powder above the current collector layer;
forming a second composite layer above the second electrolyte layer by cold spraying particles of the composite powder above the second electrolyte layer; and
forming a second current collector layer above the second composite layer by cold spraying particles of a second current collector powder above the second electrolyte layer.

24. The method as recited in claim 23, wherein a composition of the second current collector powder is the same as the substrate.

25. A method of forming a multi-stack solid-state battery, the method comprising:
performing at least two sequences of at least some of the operations for forming a multi-layer battery as recited in claim 23.

26. A method of forming a solid-state battery having a cylindrical cell configuration, the method comprising:
rotating a substrate about the longitudinal axis of the substrate while the following layers are formed thereabove by cold spraying each of the layers:
a composite layer comprising particles of a composite powder including an active component, a conductive component, and a binder;
an insulator layer comprising particles of an insulator material powder, the insulator layer formed above a first portion of the composite layer;
an electrolyte layer comprising particles of an electrolyte powder, the electrolyte layer formed above a second portion of the composite layer, wherein the first portion of the composite layer is different than the second portion of the composite layer; and
a current collector layer comprising particles of a current collector material powder, the current collector layer formed above the electrolyte layer.

27. A method of forming a multi-stack solid-state battery having a cylindrical cell configuration, the method comprising:
performing at least two sequences of at least some of the operations for forming a multi-layer battery as recited in claim 26.
